(19) United States
(12) Patent Application Publication
(10) Pub. No.: US 2026/0056590 A1
(43) Pub. Date: Feb. 26, 2026

(54) CONTROLLER FOR A POWER DEVICE, POWER ASSEMBLY WITH SUCH A CONTROLLER AND METHOD FOR OPERATING A POWER DEVICE

(71) Applicant: Rolls-Royce Solutions GmbH, Friedrichshafen (DE)

(72) Inventor: Karsten Harder, Oberteuringen (DE)

(73) Assignee: Rolls-Royce Solutions GmbH, Friedrichshafen (DE)

(21) Appl. No.: 19/371,686

(22) Filed: Oct. 28, 2025

Related U.S. Application Data
(63) Continuation of application No. PCT/EP2024/061310, filed on Apr. 24, 2024.

(30) Foreign Application Priority Data
Apr. 28, 2023 (DE) 10 2023 111 115.9
Apr. 24, 2024 (WO) PCT/EP2024/061310

(51) Int. Cl. G06F 1/28; G05B 15/02

(52) U.S. Cl. CPC G06F 1/28; G05B 15/02

(57) ABSTRACT

A controller for a power device, the controller including: a first optimization module, which is configured to determine a first optimized manipulated variable vector by way of a first non-evolutionary algorithm, the controller being configured to determine an actuation manipulated variable vector which includes a plurality of manipulated variables for actuating the power device; a second optimization module, which is configured to receive the first optimized manipulated variable vector from the first optimization module and to determine a second optimized manipulated variable vector by way of a second evolutionary algorithm using the first optimized manipulated variable vector; and a control module, which is configured to determine the actuation manipulated variable vector based on the second optimized manipulated variable vector.

### CROSS REFERENCE TO RELATED APPLICATIONS

This is a continuation of PCT application no. PCT/EP2024/061310, entitled “CONTROLLER FOR A POWER DEVICE, POWER ASSEMBLY COMPRISING SUCH A CONTROLLER, AND METHOD FOR OPERATING A POWER DEVICE”, filed Apr. 24, 2024, which is incorporated herein by reference. PCT application no. PCT/EP2024/061310 claims priority to German patent application no. 10 2023 111 115.9, filed Apr. 28, 2023, which is incorporated herein by reference.

### BACKGROUND OF THE INVENTION

### 1. Field of the Invention

The present invention relates to power assemblies.

### 2. Description of the Related Art

In order to find optimized manipulated variables for controlling a power device, especially with a view to achieving certain operating objectives, controllers are typically designed to implement classic, deterministic methods or methods derived therefrom. However, by way of such methods—in particular when they rely on gradients—only a local optimum within a characteristic map can be found with relative certainty. This can result in a power device being operated at one and the same operating point with different manipulated variables at different times. This may not necessarily be disadvantageous with regard to the operating objectives that are to be achieved; it is however problematic in sensitive areas where the operation of the power device must be certified. In such areas, safety reasons generally require that the power device exhibits clear operating behavior, in particular a clear assignment of manipulated variables to operating points in the characteristic map. It is, however, fundamentally possible to search for a global optimum in the characteristic map based on several starting values using simple extensions such as the branch-and-bound method; however, such methods involve a high numerical effort, which can hardly be achieved on a typical controller in real time, in particular not during the runtime of the power device.

What is needed in the art is a power device, a power assembly with a power device and such a controller and a method for operating a power device, wherein the aforementioned disadvantages are at least reduced, optionally do not occur.

### SUMMARY OF THE INVENTION

The invention relates to a controller for a power device, a power assembly with a power device and such a controller and a method for operating a power device.

The present invention provides a controller for a power device, wherein the controller is designed to determine an actuation manipulated variable vector including—as its components—manipulated variables for actuating the power device. The controller has a first optimization module, which is designed to determine a first optimized manipulated variable vector by way of a first, non-evolutionary algorithm. Moreover, the controller has a second optimization module that is designed to receive the first optimized manipulated variable vector from the first optimization module and to determine a second optimized manipulated variable vector by way of a second, evolutionary algorithm using the first optimized manipulated variable vector. Finally, the controller has a control module that is designed to determine the actuation manipulated variable vector depending on the second optimized manipulated variable vector. By combining two different optimization methods, wherein the first uses a non-evolutionary algorithm and a second uses an evolutionary algorithm, various advantages can be combined with limited numerical effort: the non-evolutionary algorithm enables a very accurate calculation, especially by seeking a local optimum, while the evolutionary algorithm expands the search in a simple and numerical controllable manner to areas of the characteristic map apart from the local optimum, so that the possibility of finding a global optimum is established. The combination of the two algorithms thus makes it possible, in particular, to search for a global optimum in real time, which is during runtime during operation of the power device, even on a conventional controller; in other words, one that has not been specifically upgraded in terms of its computing power. This ultimately allows the operation of the power device to be optimized cost-effectively, not only with regard to achieving operating goals such as the lowest possible fuel consumption or compliance with legal emission targets, but also with a view to certification.

In particular, the second optimized manipulated variable vector is determined in real time, in particular during the runtime of the controller and in particular during the runtime of the power device that is controlled by the controller. In particular, the actuation manipulated variable vector is determined in real time, in particular during the runtime of the controller and in particular during the runtime of the power device that is controlled by the controller.

In the context of the present technical teaching, a power device is understood in particular to be a device designed to provide power, in particular electrical and/or mechanical power, or to convert or consume power. The power device can thus be designed in particular as a power supply device or as a power conversion device. A power supply device is understood in particular to be a device that provides power, in particular electrical and/or mechanical power, using electrical, mechanical, chemical, or electrochemical energy—or another form of energy. A power conversion device is understood in particular to be a device that uses or consumes power, in particular electrical or mechanical power, in particular to convert or store energy, for example, to provide chemical energy in the form of certain substances such as hydrogen or methanol, or electrochemical energy, using electrical energy. In particular, the power device can be an internal combustion engine, an internal combustion engine-generator combination device, in other words a genset, a fuel cell, an energy storage device, in particular a battery, or an electrolyzer. However, the power device can also be a larger, complex system, for example, consisting of a plurality of the aforementioned devices, or in particular a computing center or a microgrid. In particular, the power device can also be a controllable or adjustable load on an electrical network.

The controller is designed in particular, to operate the power device. In one embodiment, the controller is designed to operate an internal combustion engine, an internal combustion engine-generator combination device, that is, a genset, a fuel cell, an energy storage device, in particular a battery, an electrolyzer, a computing center or microgrid, or another controllable or regulatable load on an electrical network.

The controller is designed in particular to operate, in particular to control, the power device with the actuation manipulated variable vector.

In the context of the present technical teaching, a vector, specifically a manipulated variable vector, is understood in particular to mean a combination of at least one manipulated variable, regardless of how the at least one manipulated variable is represented within the controller. In particular, any desired number or combination of manipulated variables can be understood or represented as a vector with at least one component, wherein the number of vector components corresponds to the number of manipulated variables.

In the context of the present technical teaching, a manipulated variable is understood to be a variable that is suitable for controlling an actuator of the power device. It is possible for the manipulated variable to be directly suitable for controlling the actuator, for example because it is given as a specific voltage or current that can be directly applied to the actuator in order to control it; alternatively, it is possible for the manipulated variable to be suitable for deriving, in particular calculating, at least one additional variable for direct control of the actuator. For example, the manipulated variable can be a fuel mass to be introduced into a combustion chamber of an internal combustion engine, which can be converted into at least one control variable for controlling an injector.

The at least one actuator can be an actuator or control element of the power device. In particular, the actuator can be an actuator of an engine block of an internal combustion engine, for example, an injector, a valve, or a flap. However, the actuator can also be an actuator outside the power device, in particular outside an engine block, for example, an actuator provided for influencing an externally provided cooling circuit, for example, a valve, a pump, or similar equipment, or an actuator of a transmission or an electrical device to which the power device is operatively connected.

In the context of the present technical teaching, a module is generally understood to mean, in particular, a theoretically or physically definable or delimited functional unit designed to perform at least one specific function. This may be a separate computing device, a part of a computing device, a hardware structure, or a software structure, respectively designed and intended to fulfill the at least one specific function.

In one embodiment, the controller is designed to detect, determine, or receive current operating parameters of the power device, such as measured values, i.e., an ambient temperature or ambient air pressure, target values for operation, limit values, environmental boundary conditions, and possibly other parameters. In particular, the first optimization module is designed to use the operating parameters to determine the first optimized manipulated variable vector; in particular, the first optimized manipulated variable vector is determined depending on the operating parameters.

In one embodiment, the first optimization module is designed to receive the second optimized manipulated variable vector from the second optimization module, and the second optimization module is designed to transmit the second optimized manipulated variable vector to the first optimization module. The first optimization module is designed, in particular, to determine the first optimized manipulated variable vector, in particular—within the scope of the iteration described below—a new first optimized manipulated variable vector, based on the received second optimized manipulated variable vector.

A further development of the present invention provides that the first optimization module is designed to determine the first optimized manipulated variable vector using a gradient method as the first, non-evolutionary algorithm. In particular, this allows the first optimization module to find a local optimum in the characteristic map with very high accuracy.

A further development of the invention provides that the second optimization module is designed to generate a predetermined number of test manipulated variable vectors in order to use the first optimized manipulated variable vector as an additional test manipulated variable vector, thus forming a first set of manipulated variable vectors with the power of a predetermined total number. The first set of manipulated variable vectors includes the predetermined number of test manipulated variable vectors and the first optimized manipulated variable vector as an additional test manipulated variable vector. The second optimization module is designed to determine the second optimized manipulated variable vector from the first set of manipulated variable vectors using the second evolutionary algorithm. The second optimization module can use the evolutionary algorithm to easily and with little computational effort achieve manipulated variable vectors outside the local optimum possibly found with the first optimized manipulated variable vector, and can thus contribute to finding, where possible, a global optimum and, in particular, a unique actuation manipulated variable vector for a specific operating point, especially regarding certification.

In particular, in one embodiment, the test manipulated variable vectors are randomly generated, in particular from uniformly distributed random numbers, wherein in particular a random number is generated for each component of a test manipulated variable vector. In one embodiment, the test manipulated variable vectors are generated for this purpose from uniformly distributed random numbers, which can in particular assume values from 0 to 1, that is from the closed interval [0.1]. In this embodiment, the first optimized manipulated variable vector is also standardized per component such that its components have values from 0 to 1. In particular, the value range of each manipulated variable is mapped to the interval [0.1] for this purpose. The actuation manipulated variable vector obtained later thus also has components with values from the interval [0.1]. It is then advantageously denormalized per component for controlling the assigned actuators, wherein the interval [0.1] is again mapped to the actual value range of the assigned manipulated variable.

In particular, the first set of manipulated variable vectors contains the predetermined number of test manipulated variable vectors and the first optimized manipulated variable vector as an additional test manipulated variable vector. The first set of manipulated variable vectors consists of the predetermined number of test manipulated variable vectors and the first optimized manipulated variable vector as a further test manipulated variable vector.

A further development of the invention provides that as the second evolutionary algorithm the second optimization module is designed to a) form the first set of manipulated variable vectors from the predetermined number of randomly generated test manipulated variable vectors and the first optimized manipulated variable vector received from the first optimization module as a further test manipulated variable vector; b) evaluate each test manipulated variable vector of the first set using a cost function; c) create a second set of offspring manipulated variable vectors with the power of the predetermined total number from a predetermined parent number of the test manipulated variable vectors of the first set ranked best using the cost function; d) modify the offspring manipulated variable vectors, with exception of a predetermined minority of elite manipulated variable vectors, in particular using a uniformly distributed noise process, whereby a third set of manipulated variable vectors is formed with the power of the predetermined total number, wherein the third set includes the modified offspring manipulated variable vectors and the elite manipulated variable vectors; and e) determine test manipulated variable vector ranked best using the cost function as the second optimized manipulated variable vector. This procedure makes it possible to search in a structured manner, even beyond the first optimized manipulated variable vector, for manipulated variable vectors that may be better in regard to the cost function, and, if necessary, to determine a manipulated variable vector as the second optimized manipulated variable vector that is better in terms of the cost function, in other words, more cost-effective, than the first optimized manipulated variable vector. Of course, it is also possible for the first optimized manipulated variable vector to be ranked best with regard to the cost function and, as a result, to be output as the second optimized manipulated variable vector.

In step b), the test manipulated variable vectors are ranked based on the evaluation using the cost function, with the best test manipulated variable vector, which is assigned the lowest costs according to the cost function, having the highest rank, and the test manipulated variable vector, which is assigned the highest costs according to the cost function, having the lowest rank. The costs assigned to the respective test manipulated variable vector, and thus the assigned rank, are subsequently retained in the further steps and also assigned accordingly to the offspring manipulated variable vector assigned to the test manipulated variable vector, if applicable also to the assigned elite manipulated variable vector, as well as to the assigned modified offspring manipulated variable vector, i.e., they are essentially inherited.

In one embodiment, in a first sub step b1) of step b), the test manipulated variable vectors are projected onto a permissible standardized range, wherein for each manipulated variable, which is for each component x^{j} of the test manipulated variable vectors x respectively, an acceptable range

$$0 <= {LBU}^{j} < = {x}^{j} <= {UBU}^{j} < = 1 \qquad ( 1 )$$

is determined within an interval defined by a lower limit LBU^{j} and an upper limit UBU^{j}[LBU^{j}, UBU^{j}] for the respective component x^{j}. Lower limit LBU^{j} and upper limit UBU^{j} can be redetermined, in particular, for each iteration step of the iteration explained below, in particular depending on the current operating parameters of the power device. In this way, it can be advantageously considered in particular that not every arbitrary value of a manipulated variable can be assumed at all times or may not be assumed—in particular for the protection of the power device.

Alternatively, or additionally, in a second sub-step b2) of step b), the second optimization module receives the operating parameters of the power device. These operating parameters are used, in particular, in a third sub-step b3) of step b) to calculate the cost function.

In one embodiment, in step b), particularly in third sub-step b3), the test manipulated variable vectors are evaluated using the following procedure: each test manipulated variable vector is checked to determine whether it satisfies at least one predetermined restriction, for example, with regard to a maximum permissible peak pressure in the combustion chamber or a maximum permissible emission value. If the tested test manipulated variable vector satisfies the at least one predetermined restriction, it is evaluated by calculating the cost function. If, however, the checked test manipulated variable vector violates at least one restriction selected from the at least one predetermined restriction, this test manipulated variable vector is assigned a maximum cost value of the cost function. This advantageously results in those test manipulated variable vectors that violate restrictions receiving the worst possible rating and being ranked at the bottom of the test manipulated variable vectors. The maximum cost value can be a predetermined value or can be calculated using a predetermined algorithm, in particular by adding a violation contribution to the cost function. It is possible for the at least one predetermined restriction to be changed within the iterations described below, in particular if operating parameters of the power device change. In particular, the at least one restriction can be redetermined for each iteration step of the iteration explained below, in particular depending on the operating parameters.

In one embodiment, the ranking of the test manipulated variable vectors in step b), in particular in a fourth sub-step b4), is determined by way of a sorting algorithm, in particular merge sort, depending on the evaluation by way of the cost function.

In one embodiment, the predetermined number of parents is less than the predetermined total number. In one embodiment, the predetermined total number is 10; alternatively, or in addition, the predetermined number of parents is 4.

In one embodiment, in step c), the second set of offspring manipulated variable vectors is created from the predetermined parent number of the test manipulated variable vectors of the first set that are assessed as best using the cost function in the following manner: first, in a first c-sub-step c1), first offspring manipulated variable vectors are generated from the test manipulated variable vectors that correspond to the predetermined parent number and are assessed as best according to the ranking in the following way: an offspring manipulated variable vector with the rank situated in the ranking corresponding to the predetermined parent number is generated by calculating, in particular averaging, the test manipulated variable vector with the rank corresponding to the predetermined parent number with the next higher test manipulated variable vector in the ranking, in other words, the offspring manipulated variable vector has component-wise mean values of the corresponding components of the two test manipulated variable vectors that are offset against each other. Another offspring manipulated variable vector with a rank corresponding to the predetermined parent number reduced by one is generated by similarly averaging this test manipulated variable vector with the next highest-ranked test manipulated variable vector. This continues until the highest-ranking offspring manipulated variable vector is finally generated by equating it with the highest-ranking test manipulated variable vector. In particular, this is done according to the following equations:

$${x}_{N , i}^{j} = \frac{1}{2} ( {x}_{T , i}^{j} + {x}_{T , i - 1}^{j} ) ∀ i ∈ \{ 2 , … , E \} \qquad ( 2 )$$

$${x}_{N , 1}^{j} = {x}_{T , 1}^{j} \qquad ( 3 )$$

respectively for all components j, where i∈{1, . . . , G} describes the rank in the ranking with the predetermined total number G, E is the predetermined parent number,

$${x}_{N , i}^{j}$$

is the component j of the offspring manipulated variable vector x_{N} with the rank denoted by i

$${x}_{T , i}^{j} i , and {x}_{T , i}^{j} i$$

is component j of the test manipulated variable vector xr_{T} with the rank denoted by i.

The rank of a manipulated variable vector within the ranking is higher the lower the value of i. In particular, the highest-ranking manipulated variable vector is assigned the value i=I, while the lowest-ranking manipulated variable vector is assigned the value i=G.

For example, if the predetermined number of parents is 4, the fourth-ranked offspring manipulated variable vector is generated by averaging the fourth-ranked test manipulated variable vector with the third-ranked test manipulated variable vector; the third offspring manipulated variable vector is generated by averaging the third-ranked test manipulated variable vector with the second-ranked test manipulated variable vector; the second offspring manipulated variable vector is generated by averaging the second-ranked test manipulated variable vector with the first-ranked—that is, the best or highest-ranking—test manipulated variable vector; finally, the first-ranked offspring manipulated variable vector is generated by placing it identically to the first-ranked—best—test manipulated variable vector. In particular, the highest-ranking—best—test manipulated variable vector is used as the highest-ranking offspring manipulated variable vector. Then, in a second sub-step c2), second offspring manipulated variable vectors are generated in such a way that, originating from the rank corresponding to the predetermined parent number increased by one, the offspring manipulated variable vectors are selected respectively to be identical to the previously generated first offspring manipulated variable vectors with the rank respectively reduced by the predetermined parent number, until the predetermined total number is achieved, in particular according to the following equation:

$${x}_{N , i}^{j} = {x}_{N , i - E}^{j} ∀ i ∈ \{ E + 1 , … , G \} \qquad ( 4 )$$

If, for example, the predetermined total number is 10 and the predetermined parent number is 4, the fifth offspring manipulated variable vector in the ranking is now selected to be identical to the first offspring manipulated variable vector, the sixth offspring manipulated variable vector is selected to be identical to the second offspring manipulated variable vector, the seventh offspring manipulated variable vector is selected to be identical to the third offspring manipulated variable vector, the eighth offspring manipulated variable vector is selected to be identical to the fourth offspring manipulated variable vector, the ninth offspring manipulated variable vector is selected to be identical to the fifth offspring manipulated variable vector—and thus also identical to the first offspring manipulated variable vector—and the tenth offspring manipulated variable vector is selected to be identical to the sixth offspring manipulated variable vector—and thus also identical to the second offspring manipulated variable vector.

In particular, the second set of offspring manipulated variable vectors contains the predetermined total number of offspring manipulated variable vectors. In particular, the second set of offspring manipulated variable vectors consists of the predetermined total number of offspring manipulated variable vectors.

In particular, the offspring manipulated variable vectors are mutated in step d).

In particular, the elite manipulated variable vectors used are the highest-ranking offspring manipulated variable vectors corresponding to the predetermined subset U in the ranking order. In particular, the predetermined subset U is smaller than the predetermined total number G. In one embodiment, the predetermined subset U=2; in this case, the elite manipulated variable vectors are the first, highest-ranking offspring manipulated variable vector and the second offspring manipulated variable vector immediately following in the ranking order.

In one embodiment, in step d), the offspring manipulated variable vectors, with exception of the predetermined minority U of elite manipulated variable vectors, are modified, in particular mutated, according to the following procedure, wherein the third set of manipulated variable vectors is formed: a modified offspring manipulated variable vector is formed from the offspring manipulated variable vector corresponding in the ranking by calculating its components with a particularly uniformly distributed random number, which is selected in particular from interval [0.1], taking into account a weight factor, which is selected in particular from the interval [0.1]. In particular, the respective component is multiplied by the difference of the weight factor to 1, and the product of the random number and the weight factor is added to the result. Advantageously, the offspring manipulated variable vectors, with the exception of the predetermined minority of elite manipulated variable vectors, are modified using a uniformly distributed noise process.

In one embodiment, the weighting factor is selected depending on the rank of the offspring manipulated variable vector to be changed within the ranking, in particular, the lower the rank of the offspring manipulated variable vector the higher the weighting factor. Higher-ranking offspring manipulated variable vectors are thus changed less than lower-ranking offspring manipulated variable vectors, or in other words, lower-ranking offset manipulated variable vectors are changed more significantly than higher-ranking offset manipulated variable vectors. In one embodiment, the relationship between the weighting factor and position i in the ranking is linear; as explained above, higher values of i correspond to a lower rank. Alternatively or additionally, in one embodiment a distance, in particular a Euclidean distance, between the offspring manipulated variable vector to be changed and the first optimized manipulated variable vector is calculated to determine the weighting factor, wherein the weighting factor is selected to be at a maximum, in particular equal to 1, if the distance between the offspring manipulated variable vector to be changed and the first optimized manipulated variable vector is smaller than a predetermined limit distance. In one embodiment, the predetermined threshold distance is 0.1. However, if the distance is greater than or equal to the predetermined threshold distance, the weighting factor is selected—as previously described—depending on the position of the offspring manipulated variable vector within the ranking.

In particular, each component j of the offspring manipulated variable vectors x_{N} to be changed is changed according to the following equation:

$${x}_{m , i}^{j} = ( 1 - {a}_{i} ) {x}_{N , i}^{j} + {a}_{i} \cdot {z}_{i}^{j} ∀ i ∈ \{ U + 1 , … , G \} , \qquad ( 5 )$$

wherein xₘ is the changed offspring manipulated variable vector, aᵢ is the weighting factor from interval [0.1] assigned

$${z}_{i}^{j}$$

to the respective offspring manipulated variable vector x_{N} to be changed, and aᵢ is the random number newly generated, in particular uniformly distributed, from interval [0.1] for each component of each offspring manipulated variable vector x_{N}. The value of aᵢ is greater, the greater i is. In one embodiment, function aᵢ (i) is a linear function. It is possible to additionally select aᵢ=1 if the distance—in particular the Euclidean distance—between the offspring manipulated variable vector to be changed and the first optimized manipulated variable vector is smaller than a predetermined threshold distance, in particular smaller than 0.1.

In one embodiment, however, an offspring manipulated variable vector is not changed if it is identical to the first optimized manipulated variable vector. Alternatively, or in addition, such an offspring manipulated variable vector—in deviation from the procedure according to the distance—is changed depending on its rank, in particular according to equation (5), if it is identical to the first optimized manipulated variable vector. Another embodiment provides that an offspring manipulated variable vector identical to the first optimized manipulated variable vector with a relatively high rank, for example—in particular parameterizable—from 1 to 4, is not changed, while an offspring manipulated variable vector identical to the first optimized manipulated variable vector with a relatively low rank, for example, from 5 to 10, is changed depending on its rank, in particular according to equation (5). In particular, this procedure can have an advantageous accelerating effect on the search for a global optimum, in particular in the area of a local optimum.

In particular, the third set contains the modified offspring manipulated variable vectors and the elite manipulated variable vectors. In particular, the third set consists of the modified offspring manipulated variable vectors and the elite manipulated variable vectors.

In particular, in step e), the second optimized manipulated variable vector is output to the control module, which, based thereupon determines the actuation manipulated variable vector. In particular, in step e), the second optimized manipulated variable vector is additionally transferred to the first optimization module, which then determines a new first optimized manipulated variable vector based on the second optimized manipulated variable vector.

A further development of the invention provides that the second optimization module is further designed to f) receive the new, first optimized manipulated variable vector from the first optimization module and to form a fourth set of manipulated variable vectors with the power of the predetermined total number by replacing a manipulated variable vector from the third set with the new, first optimized manipulated variable vector, and g) to repeat steps b) to f) with the fourth set obtained in step f) as the first set, until a predetermined termination condition is met. In this way, the search for an optimal actuation manipulated variable vector is advantageously carried out iteratively, wherein new developments, in particular changed operating conditions, are considered by adding the respective new, first optimized manipulated variable vector.

In one embodiment, the determination of first optimized manipulated variable vectors by the first optimization module is performed with a first timing cycle having a first sampling time, wherein determination of second optimized manipulated variable vectors by the second optimization module, in particular execution of steps b) to f), is performed with a second timing cycle and a second sampling time, wherein the first sampling time is shorter than the second sampling time. In particular, the first sampling time in one embodiment is 10 ms; alternatively, or in addition, the second sampling time is 100 ms. Thus, in particular, a first optimized manipulated variable vector is determined more often than a second optimized manipulated variable vector. Therefore, not every newly determined first optimized manipulated variable vector is considered as a new first optimized manipulated variable vector in step f), but rather, for example, every tenth newly determined first optimized manipulated variable vector for the specific sampling times mentioned.

In particular, as described above, the new first optimized manipulated variable vector is determined by the first optimization module based on the second optimized manipulated variable vector determined in the previous iteration run. This ensures that the more accurate first non-evolutionary algorithm searches for the first optimized manipulated variable vector in the region of the characteristic map by identifying the position of a possible global optimum using the second, evolutionary algorithm. Thus, the advantages of both algorithms are skillfully combined, and as a result a very accurate solution for the global optimum can be iterated out.

To form the fourth set, the lowest-ranking, worst-rated manipulated variable vector, in particular the manipulated variable vector assigned the rank i=G, is replaced in one embodiment by the new first optimized manipulated variable vector.

In particular, the fourth set contains the predetermined total number of manipulated variable vectors. In particular, the fourth set consists of the predetermined total number of manipulated variable vectors.

In one embodiment, the predetermined termination condition is checked in step e), wherein step f) and thus also the subsequent steps g) and b) to e) are only carried out again if the termination condition is not met.

In one embodiment, the predetermined termination condition is defined by reaching a predetermined maximum iteration number. Alternatively, or additionally, the predetermined termination condition is defined by reaching a predetermined maximum iteration time.

Alternatively, or additionally, the predetermined termination condition is the shutdown of the controller or the power device. In one embodiment, the maximum iteration number—in particular to ensure the real-time capability of the method—can be 1, so that only exactly one run is performed. In other cases, particularly when more computing power is available or no real-time system is used, the maximum iteration number can also be greater than 1. A maximum iteration time can be used in embodiments in which, in the event of an error, invalid species are generated to such an extent that the model calculates invalid values, which could otherwise lead to a massive increase in the runtime. A maximum iteration time can also be used if no real-time system is used, whereby the available computing capacity can vary. By specifying the maximum iteration time, it can be ensured that no outdated solution is further calculated.

A further development of the invention provides that the first optimization module is designed to determine the first optimized manipulated variable vector for a predetermined prediction interval. In particular, the first optimization module is designed to determine the first optimized manipulated variable vector for the end of the predetermined prediction interval. Thus, the first optimized manipulated variable vector is quasi determined for the future, in particular as a goal to be achieved.

A further development of the invention provides that the control module is designed to determine the actuation manipulated variable vector by way of a model-based predictive method, by penalizing any deviation of the actuation manipulated variable vector from the second optimized manipulated variable vector. This advantageously ensures that the actuation manipulated variable vector determined by the control module develops in the direction of the second optimized manipulated variable vector.

In the context of the present technical teaching, a model-based predictive method is understood in particular to mean a model predictive control (Model Predictive Control—MPC).

In particular, the control module is designed to calculate the actuation manipulated variable vector by way of a Gaussian process model. Alternatively, or in addition, the first optimization module is designed to calculate the first optimized manipulated variable vector by way of a Gaussian process model, in particular using the same Gaussian process model that the control module also uses.

Gaussian process models are particularly suitable for modeling and/or controlling a power device: compared to polynomial-based models, they are especially easier to adapt to new or changed data points in the field of application, and they exhibit more suitable and physically correct behavior in the boundary regions of the provided parameter space. Compared to physical models, they require significantly less computational effort. Moreover, they enable the direct use of test bench data, data from particularly high-precision simulations or models, or even field data from the field of application. Such a Gaussian process model is provided in particular by stored data points (X_{b}, Y_{b}), for example obtained in test bench tests or from simulations or models, wherein X_{b}∈ [symbol] ^{n×m} denotes in particular n input variables for m different operating states, and Y_{b}∈ [symbol] ^{m×k} denotes in particular k output variables for the m different operating states. The output variables Y_{b} are in particular a subset of the at least one manipulated variable. Moreover, the Gaussian process model is characterized by a specified calculation scheme for an expectation value E(Xᵤ)∈ [symbol] ^{l×k} and a variance Var(Xᵤ) for input variables not contained in the original data set for l different operating states Xᵤ∈ [symbol] ^{n×l}:

$$E ( {X}_{u} ) = m ( {X}_{u} ) + K ( {X}_{u} , {X}_{b} ) {( K ( {X}_{b} , {X}_{b} ) + {σ}^{2} I )}^{- 1} ( {y}_{b} - m ( {X}_{b} ) ) , \qquad ( 6 )$$

$$\begin{matrix}Var ( {X}_{u} ) = K ( {X}_{u} , {X}_{u} ) + {σ}^{2} - K ( {X}_{u} , {X}_{b} ) {( K ( {X}_{b} , {X}_{b} ) + {σ}^{2} I )}^{- 1} K ( {X}_{b} , {X}_{u} ) , & ( 7 )\end{matrix}$$

with a mean function m(Xᵤ), a predetermined variance σ², identity matrix I, and a covariance function K, which depends on the Euclidean distance r between two points x₁, x₂ in the following way:

$$K ( {X}^{1} , {X}^{2} ) = {( k ( {X}_{1 : n , i}^{1} , {X}_{1 : n , j}^{2} ) )}_{i = 1 , … , m , j = 1 , … , m} , \qquad ( 8 )$$

$$k ( {x}_{1} , {x}_{2} ) = {σ}_{F}^{2} exp ( - \frac{{r ( {x}_{1} , {x}_{2} )}^{2}}{2 {l}^{2}} ) , \qquad ( 9 )$$

with a predetermined distance parameter l and a predetermined signal variance σ_{F}. Thus, in equations (6) and (7) K(Xᵤ, X_{b})∈ [symbol] ^{l×m}, K(X_{b}, X_{b})∈ [symbol] ^{mx}, I∈ [symbol] ^{m×m} and Y_{b}∈ [symbol] ^{m×k}.

The mean function m(x) is optionally obtained again as a Gaussian process model.

In particular, an initial Gaussian process model, also referred to as a basic grid, is first adapted to second inventory data using at least one secondary condition derived from first inventory data, i.e., test bench data or data obtained from models or simulations, especially high-precision ones. In particular, input variables X_{b} are selected, and the associated output variables Y_{b} are calculated such that a deviation of expected value E(X) of the first Gaussian process model, which is determined from input variables X_{b} and output variables Y_{b}, from the second inventory data is minimized while observing the secondary condition. Furthermore, for the purpose of determining the first Gaussian process model, it is optionally assumed that its mean value function m(x)=0. The first inventory data include a greater parameter space than the second inventory data. For example, for an internal combustion engine, it is possible that the first set of inventory data are measured on a single-cylinder test bench, while the second set of inventory data are measured on a full-size engine or also on a single-cylinder test bench and, in the latter case, are converted to the full-size engine—optionally using a simulation model. The secondary condition is optionally obtained as a trend wherein, for example, it is determined whether certain parameters behave linearly or monotonic with respect to one another. If no such trend is detected, the secondary condition can be omitted, in which case the fit of the Gaussian process model to the second set of data is also referred to as unconstrained.

The thus obtained expected value of the first Gaussian process model is then used in a next step as the mean function m(x) in a second Gaussian process model, into which the second inventory data are now entered as known input variables X_{b2} and output variables Y_{b2}.

A further development of the invention provides that the control module is designed to determine a manipulated variable vector trajectory for the predetermined prediction interval and to determine a current manipulated variable vector of the manipulated variable vector trajectory as the actuation manipulated variable vector. In particular, this advantageously ensures that the actuation manipulated variable vector determined by the control module develops toward the second optimized manipulated variable vector and thus in particular, toward the global optimum.

A further development of the invention provides that the first optimization module is designed to calculate the first optimized manipulated variable vector in a steady-state manner. This allows for a particularly simple and, in terms of computational costs, cost-effective calculation of the first optimized manipulated variable vector, since system dynamics are not considered in this case.

According to a further development of the invention, the control module is designed to calculate the actuation manipulated variable vector, in particular the manipulated variable vector trajectory, by considering the dynamics of the power device. In this way, the dynamics of the system are taken into account in the control module, whereby consideration of the dynamics in the first optimization module can advantageously be omitted.

The present invention also provides a power assembly which includes a power device and a controller according to the invention or a controller according to one or more of the previously described embodiments. In connection with the power assembly, the advantages already described above in connection with the controller are realized in particular.

In particular, the controller is operatively connected to the power device in order to control the power device.

One embodiment provides that the power device is designed as an internal combustion engine, an internal combustion engine-generator combination device, which is a genset, a fuel cell, an energy storage device, in particular a battery, an electrolyzer, a data center or a microgrid, or as another controllable or regulatable load on an electrical network.

The present invention also provides a method for operating a power device, wherein a first optimized manipulated variable vector is determined by way of a first, non-evolutionary algorithm, a second optimized manipulated variable vector is determined by way of a second, evolutionary algorithm using the first optimized manipulated variable vector, an actuation manipulated variable vector is determined depending on the second optimized manipulated variable vector, and wherein the power device is operated with the actuation manipulated variable vector. In connection with the method, in particular, those advantages that were already described above in connection with the controller and the power assembly are realized.

One embodiment provides that an internal combustion engine, an internal combustion engine-generator combination device, which is a genset, a fuel cell, an energy storage device, in particular a battery, an electrolyzer, a data center or microgrid, or another controllable or regulatable load is operated on an electrical network as the power device.

In one embodiment, the first optimized manipulated variable vector is determined by way of a gradient method as the first non-evolutionary algorithm.

In one embodiment, a predetermined number of test manipulated variable vectors is generated, and the first optimized manipulated variable vector is used as another test manipulated variable vector, so that a first set of manipulated variable vectors with the power of a predetermined total number is formed. The first set of manipulated variable vectors includes the predetermined number of test manipulated variable vectors and the first optimized manipulated variable vector as another test manipulated variable vector. The second optimized manipulated variable vector is determined from the first set of manipulated variable vectors using the second evolutionary algorithm.

In one embodiment: a) the first set of manipulated variable vectors is formed from the predetermined number of randomly generated test manipulated variable vectors and the first optimized manipulated variable vector received from the first optimization module as a further test manipulated variable vector; b) each test manipulated variable vector of the first set is evaluated by way of a cost function; c) a second set of descendant manipulated variable vectors with the power of the predetermined total number is formed from a predetermined parent number of the test manipulated variable vectors of the first set that were evaluated as best by way of the cost function; d) the offspring manipulated variable vectors are modified with the exception of a predetermined subset of elite manipulated variable vectors, wherein a third set of manipulated variable vectors with the power of the predetermined total number is formed, wherein the third set includes the modified offspring manipulated variable vectors and the elite manipulated variable vectors; and e) the test manipulated variable vector that was evaluated as best by way of the cost function is determined as the second optimized manipulated variable vector.

Moreover, in one embodiment: f) a new first optimized manipulated variable vector is received from the first optimization module, and a fourth set of manipulated variable vectors with the power of the predetermined total number is formed in that a manipulated variable vector of the third set is replaced by the new first optimized manipulated variable vector, and g) steps b) to f) are repeated with the fourth set obtained in step f) as the first set, in particular until a predetermined termination condition is met.

In one embodiment, the first optimized manipulated variable vector is determined for a predetermined prediction interval. In particular, the first optimized manipulated variable vector is determined for the end of the predetermined prediction interval.

In one embodiment, the actuation manipulated variable vector is determined by way of a model-based, predictive method penalizing a deviation of the actuation manipulated variable vector from the second optimized manipulated variable vector.

In one embodiment, a manipulated variable vector trajectory is determined for the predetermined prediction interval, and a current manipulated variable vector of the manipulated variable vector trajectory is determined as the actuation manipulated variable vector.

In one embodiment in particular, the first optimized manipulated variable vector is calculated in a stationary state.

In one embodiment, the actuation manipulated variable vector, in particular the manipulated variable vector trajectory, is calculated by taking into account a dynamic of the power device.

In particular, the controller according to the invention or a controller according to one or more of the previously described embodiments is designed to carry out the method according to the invention or a method according to one or more of the previously described embodiments. The description of the controller, on the one hand, and of the method, on the other hand, are to be understood as complementary. In particular, the method includes at least one step or a combination of steps that were previously described explicitly or implicitly in connection with the controller.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of a design example of a power assembly with a design example of a controller;

FIG. 2 is a schematic representation of a design example of a method for operating a power device in the form of a flow chart; and

FIG. 3 is a schematic representation of a detail of the method according to FIG. 2.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

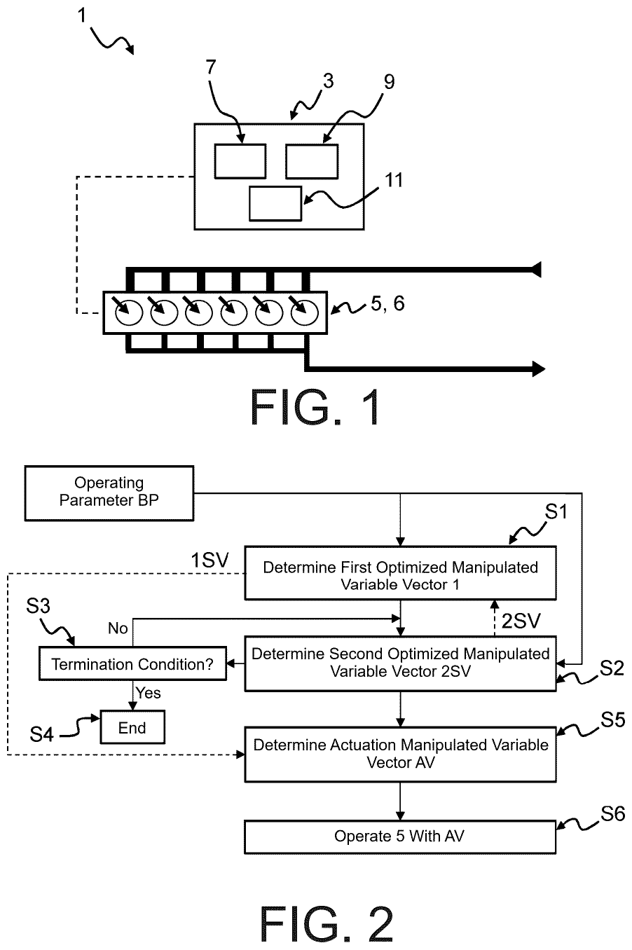

FIG. 1 is a schematic representation of a design example of a power assembly 1 with a design example of a controller 3.

Power assembly 1 also has a power device 5 which is operatively connected to controller 3 so that controller 3 can control power device 5.

In the herein presented design example, power device 5 is designed as an internal combustion engine 6. It can, however, also be designed, in particular, as an internal combustion engine-generator combination device, which is a genset, fuel cell, energy storage device, in particular a battery, electrolyzer, data center, or microgrid, or as another controllable or regulatable load on an electrical network.

Controller 3 is designed to determine an actuation manipulated variable vector including manipulated variables for actuating power device 5. For this purpose, it has a first optimization module 7, which is designed to determine a first optimized manipulated variable vector using a first, non-evolutionary algorithm, a second optimization module 9, which is designed to receive the first optimized manipulated variable vector from first optimization module 7 and to determine a second optimized manipulated variable vector by way of the first optimized manipulated variable vector using a second, evolutionary algorithm, and a control module 11, which is designed to determine the actuation manipulated variable vector depending on the second optimized manipulated variable vector.

In particular, controller 3 is designed to carry out an embodiment of a method for operating power device 5 described below.

FIG. 2 is a schematic representation in the form of a flow chart of an embodiment of a method for operating power device 5.

Identical and functionally identical elements are provided with the same reference symbols in all drawings, so that reference is made to the prior description in each case.

Within the scope of the method, a first optimized manipulated variable vector is determined in particular by way of a first, non-evolutionary algorithm, and a second optimized manipulated variable vector is determined by way of a second, evolutionary algorithm using the first optimized manipulated variable vector, wherein an actuation manipulated variable vector is determined depending on the second optimized manipulated variable vector, and wherein the power device is operated with the actuation manipulated variable vector.

In one embodiment, the first optimized manipulated variable vector is determined by way of a gradient method as the first non-evolutionary algorithm.

In particular, in a first step S1, the first optimized manipulated variable vector 1SV is determined, in particular calculated, by first optimization module 7 by way of a first, non-evolutionary algorithm. For this purpose, first optimization module 7 uses, in particular, operating parameters BP of power device 5, wherein operating parameters BP are included in the determination of first optimized manipulated variable vector 1SV. Operating parameters BP can be received, in particular, by first optimization module 7 or another module of controller 3—in particular via at least one suitable interface, for example of sensors—or they can be determined, in particular calculated, or simulated, by first optimization module 7 or another module of controller 3 itself, in particular based on measured values determined by at least one sensor.

Operating parameters BP are optionally selected from a group consisting of an ambient temperature, an ambient air pressure, a target value for the operation of power device 5, a threshold value for the operation of power device 5, at least one ambient boundary condition, and a combination of at least two of the aforementioned parameters. Operating parameters BP may also include other parameters not explicitly mentioned here.

First optimized manipulated variable vector 1SV is optionally determined by first optimization module 7 for a predetermined prediction interval. In particular, the first optimized manipulated variable vector is determined for the end of the predetermined prediction interval.

In particular, first optimized manipulated variable vector 1SV is calculated using a gradient method. Alternatively, or in addition, first optimized manipulated variable vector 1SV is calculated in a steady-state fashion. First optimized manipulated variable vector 1SV is optionally calculated using a model-based, predictive method, in particular using the same method that is also used by control module 11 to calculate the actuation manipulated variable vector; however, first optimized manipulated variable vector 1SV is optionally calculated in a steady-state manner, while the dynamics of power device 5 are included for calculating the actuation manipulated variable vector.

In second step S2, first optimized manipulated variable vector 1SV is received by second optimization module 9 from first optimization module 7, and a second optimized manipulated variable vector 2SV is determined, in particular calculated, by second optimization module 9 by use of a second evolutionary algorithm using first optimized manipulated variable vector 1SV.

Optionally, a predetermined number of test manipulated variable vectors is generated for this purpose, and first optimized manipulated variable vector 1SV is used as a further test manipulated variable vector, so that a first set of manipulated variable vectors with the power of a predetermined total number is formed. The first set of manipulated variable vectors includes the predetermined number of test manipulated variable vectors and first optimized manipulated variable vector 1SV as a further test manipulated variable vector. Second optimized manipulated variable vector 2SV is determined from the first set of manipulated variable vectors using the second, evolutionary algorithm.

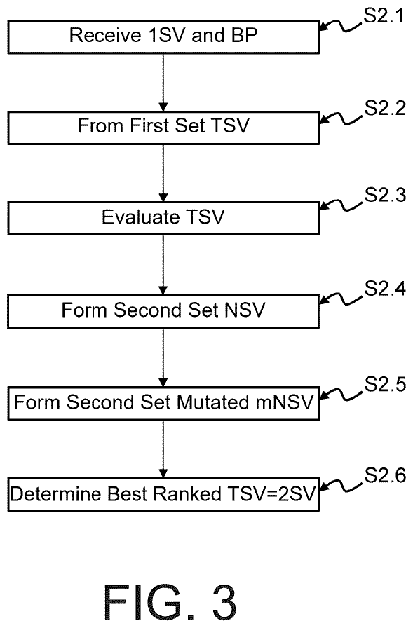

Operating parameters BP are again used to determine second optimized manipulated variable vector 2SV, particularly for calculating a cost function used to evaluate the test manipulated variable vectors. The determination of second optimized manipulated variable vector 2SV is explained in more detail in connection with FIG. 3.

In particular—as illustrated by a dashed arrow—second optimized manipulated variable vector 2SV determined in second step S2 is transmitted to first optimization module 7. First step S1 is repeated, in particular, with a first timing cycle having a first sampling time, wherein a new first optimized manipulated variable vector 1SV is determined in each case based on the currently transmitted second optimized manipulated variable vector 2SV. As also illustrated by a dashed arrow, each newly determined first optimized manipulated variable vector 1SV is optionally transferred to control module 11 in order to determine actuation manipulated variable vector AV. Second step S2 is optionally repeated with a second timing cycle having a second sampling time, wherein the first sampling time is, in particular, shorter than the second sampling time. Optionally, if no new second optimized manipulated variable vector 2SV is currently available, the respective current, new first optimized manipulated variable vector 1SV is used by control module 11 instead of the last received second optimized manipulated variable vector 2SV to determine actuation manipulated variable vector AV.

Originating from second step S2, a third step S3 checks whether a predetermined termination condition is met. If this is not the case, second step S2 is repeated, with a new second optimized manipulated variable vector 2SV being determined using a new first optimized manipulated variable vector 1SV, which is again currently received by first optimization module 7. Second and third steps S2 and S3 are repeated until the predetermined termination condition is met in third step S3. If this is the case, the method ends in a fourth step S4.

Repetition of second and third steps S2 and S3 optionally occurs with the second time cycle having the second sampling time. In particular, the first sampling time is shorter than the second sampling time. Optionally, the first sampling time is 10 ms, and the second sampling time is 100 ms. Thus, the first step is performed more frequently than the iteration of second and third steps S2 and S3.

Simultaneously with the iteration of second and third steps S2 and S3 described in the previous paragraph, each newly determined second optimized manipulated variable vector 2SV in current second step S2 is always transferred to control module 11, which, in a fifth step S5, determines an actuation manipulated variable vector AV depending on second optimized manipulated variable vector 2SV. If no new second optimized manipulated variable vector 2SV is currently received, but a new first optimized manipulated variable vector 1SV is, actuation manipulated variable vector AV is determined depending on the new first optimized manipulated variable vector 1SV.

Actuation manipulated variable vector AV is optionally determined by control module 11 using a model-based, predictive method, penalizing a deviation of actuation manipulated variable vector AV from second optimized manipulated variable vector 2SV—or alternatively, the new first optimized manipulated variable vector 1SV. In particular, a manipulated variable vector trajectory is optionally determined for the predetermined prediction interval, and a current manipulated variable vector of the manipulated variable vector trajectory is determined as the actuation manipulated variable vector AV. In particular, actuation manipulated variable vector AV, in particular the manipulated variable vector trajectory, is optionally calculated by taking into account the dynamics of power device 5.

In a sixth step S6, power device 5 is then operated by way of actuation manipulated variable vector AV determined in fifth step S5, in particular by controlling power devices 5 with the manipulated variables included as components by actuation manipulated variable vector AV.

FIG. 3 shows a schematic representation of a detail of the method according to FIG. 2. In particular, the determination of second optimized manipulated variable vector 2SV in second step S2 is explained in more detail with reference to FIG. 3.

First, in a first second step S2.1, first optimized manipulated variable vector 1SV and operating parameters BP are received.

In a second step S2.2, the predetermined number G−1 of test manipulated variable vectors TSV is randomly generated, and the first set of manipulated variable vectors with the power of predetermined total number G is formed from predetermined number G−1 of randomly generated test manipulated variable vectors TSV and first optimized manipulated variable vector 1SV received from first optimization module 7 as a further test manipulated variable vector TSV.

In a third second step S2.3, each test manipulated variable vector TSV of the first set is evaluated using a cost function, in particular by taking into account operating parameters BP.

In a fourth second step S2.4, a second set of offspring manipulated variable vectors NSV with the power of predetermined total number G is formed from a predetermined parent number E of test manipulated variable vectors TSV of the first set that are evaluated as best by way of the cost function.

In a fifth second step S2.5, offspring manipulated variable vectors NSV are mutated with the exception of a predetermined subset U of elite manipulated variable vectors, forming a third set of manipulated variable vectors with the power of predetermined total number G, wherein the third set includes the mutated descendant manipulated variable vectors mNSV and the elite manipulated variable vectors.

Finally, in a sixth second step S2.6, the test manipulated variable vector TSV evaluated as best by way of the cost function is determined as second optimized manipulated variable vector 2SV.

Returning to FIG. 2, during the iteration of second and third steps S2 and S3, a new first optimized manipulated variable vector 1SV is always received from the first optimization module 7 in each further execution of first second step S2.1 by second optimization module 9, and, in each further implementation of second step S2.2, a fourth set of manipulated variable vectors with the power of the predetermined total number G is formed by replacing a manipulated variable vector of the third set with the new first optimized manipulated variable vector 1SV. In particular, to form the fourth set, the lowest-ranking, worst-rated manipulated variable vector is replaced by new first optimized manipulated variable vector 1SV. The newly formed fourth set is then used as the new first set. The further iteration steps, in particular steps S2.3 to S2.6, are then repeated with the fourth set formed in second step S2.2 as the new first set, in particular until the predetermined termination condition is met in third step S3.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A controller for a power device, the controller comprising:
a first optimization module, which is configured to determine a first optimized manipulated variable vector by way of a first non-evolutionary algorithm, the controller being configured to determine an actuation manipulated variable vector which includes a plurality of manipulated variables for actuating the power device;
a second optimization module, which is configured to receive the first optimized manipulated variable vector from the first optimization module and to determine a second optimized manipulated variable vector by way of a second evolutionary algorithm using the first optimized manipulated variable vector; and
a control module, which is configured to determine the actuation manipulated variable vector based on the second optimized manipulated variable vector.

2. The controller according to claim 1, wherein the first optimization module is configured to determine the first optimized manipulated variable vector by way of a gradient method as the first non-evolutionary algorithm.

3. The controller according to claim 1, wherein the second optimization module is configured:
(i) to generate a predetermined number of test manipulated variable vectors in order to use the first optimized manipulated variable vector as an additional test manipulated variable vector so that a first set of manipulated variable vectors with a power of a predetermined total number of manipulated variable vectors is formed, wherein the first set of manipulated variable vectors includes the predetermined number of test manipulated variable vectors and the first optimized manipulated variable vector as the additional test manipulated variable vector, and
(ii) to determine the second optimized manipulated variable vector from the first set of manipulated variable vectors using the second evolutionary algorithm.

4. The controller according to claim 3, wherein the second optimization module is configured:
(a) to form the first set of manipulated variable vectors with the power of the predetermined total number of manipulated variable vectors from a predetermined number of randomly generated test manipulated variable vectors and the first optimized manipulated variable vector received from the first optimization module as the additional test manipulated variable vector, wherein the first set of test manipulated variable vectors includes the predetermined total number of test manipulated variable vectors and the first optimized manipulated variable vector as the additional test manipulated variable vector;
(b) to evaluate each said test manipulated variable vector of the first set of test manipulated variable vectors by way of a cost function;
(c) to create a plurality of offspring manipulated variable vectors with the power of the predetermined total number of manipulated variable vectors from a predetermined parent number of test manipulated variable vectors of the first set of test manipulated variable vectors ranked best using the cost function;
(d) to modify the plurality of offspring manipulated variable vectors, with exception of a predetermined set of elite manipulated variable vectors, wherein a third set of manipulated variable vectors is formed with the power of the predetermined total number of manipulated variable vectors, wherein the third set of manipulated variable vectors includes the plurality of offspring manipulated variable vectors—which are modified—and the predetermined set of elite manipulated variable vectors; and
(e) to determine which one of the first set of test manipulated variable vectors is ranked best using the cost function as the second optimized manipulated variable vector.

5. The controller according to claim 4, wherein the second optimization module is further configured:
(f) to receive a new first optimized manipulated variable vector from the first optimization module and to form a fourth set of manipulated variable vectors with the power of the predetermined total number of manipulated variable vectors by replacing a respective manipulated variable vector from the third set of manipulated variable vectors with the new first optimized manipulated variable vector; and
(g) to repeat steps (b) to (f) with the fourth set of manipulated variable vectors obtained in step (f) as the first set of manipulated variable vectors.

6. The controller according to claim 4, wherein the second optimization module is further configured:
(f) to receive a new first optimized manipulated variable vector from the first optimization module and to form a fourth set of manipulated variable vectors with the power of the predetermined total number of manipulated variable vectors by replacing a respective manipulated variable vector from the third set of manipulated variable vectors with the new first optimized manipulated variable vector; and
(g) to repeat steps (b) to (f) with the fourth set of manipulated variable vectors obtained in step (f) as the first set of manipulated variable vectors until a predetermined termination condition is met.

7. The controller according to claim 1, wherein the first optimization module is configured to determine the first optimized manipulated variable vector for a predetermined prediction interval.

8. The controller according to claim 1, wherein the first optimization module is configured to determine the first optimized manipulated variable vector for an end of a predetermined prediction interval.

9. The controller according to claim 1, wherein the control module is configured to determine the actuation manipulated variable vector by way of a model-based predictive method, by penalizing any deviation of the actuation manipulated variable vector from the second optimized manipulated variable vector.

10. The controller according to claim 1, wherein the first optimization module is configured to determine the first optimized manipulated variable vector for a predetermined prediction interval, wherein the control module is configured to determine a manipulated variable vector trajectory for the predetermined prediction interval and to determine a current manipulated variable vector of the manipulated variable vector trajectory as the actuation manipulated variable vector.

11. The controller according to claim 1, wherein the first optimization module is configured to calculate the first optimized manipulated variable vector in a stationary state.

12. The controller according to claim 1, wherein the control module is configured to calculate the actuation manipulated variable vector by considering a plurality of dynamics of the power device.

13. The controller according to claim 1, wherein the first optimization module is configured to determine the first optimized manipulated variable vector for a predetermined prediction interval, wherein the control module is configured to determine a manipulated variable vector trajectory for the predetermined prediction interval and to determine a current manipulated variable vector of the manipulated variable vector trajectory as the actuation manipulated variable vector, wherein the control module is configured to calculate the manipulated variable vector trajectory by considering a plurality of dynamics of the power device.

14. A power assembly, comprising:
a power device; and
a controller for a power device, the controller being configured to determine an actuation manipulated variable vector which includes a plurality of manipulated variables for actuating the power device, the controller including:
a first optimization module, which is configured to determine a first optimized manipulated variable vector by way of a first non-evolutionary algorithm;
a second optimization module, which is configured to receive the first optimized manipulated variable vector from the first optimization module and to determine a second optimized manipulated variable vector by way of a second evolutionary algorithm using the first optimized manipulated variable vector; and
a control module, which is configured to determine the actuation manipulated variable vector based on the second optimized manipulated variable vector.

15. A method for operating a power device, the method comprising the steps of:
determining a first optimized manipulated variable vector by way of a first non-evolutionary algorithm;
determining a second optimized manipulated variable vector by way of a second evolutionary algorithm using the first optimized manipulated variable vector;
determining an actuation manipulated variable vector depending on the second optimized manipulated variable vector; and
operating the power device with the actuation manipulated variable vector.
